(19) United States
(12) Patent Application Publication
(10) Pub. No.: US 2013/0033421 A1
(43) Pub. Date: Feb. 7, 2013

(54) CHANGEABLE INTERACTIVE SURFACE WITH RESIZING, ZOOMING, MOVING, ROTATING AND OTHER MANIPULATION OPTIONS/CONTROLS

(71) Applicant: Uros S. Lencic, Sentjernej (SI)

(72) Inventor: Uros S. Lencic, Sentjernej (SI)

(73) Assignee: Ordo Group, LLC

(21) Appl. No.: 13/565,885

(22) Filed: Aug. 3, 2012

Related U.S. Application Data
(60) Provisional application No. 61/514,957, filed on Aug. 4, 2011.

(51) Int. Cl. G06F 3/01

(52) U.S. Cl. 345/156

(57) ABSTRACT

Systems and methods to allow a user of an electronic device to change the size, rotation, zoom and/or position of a drawing surface used with a graphics-based user interface, using characteristic changing controls positioned within the drawing surface, adjacent to the drawing surface or both within and adjacent to the drawing surface.

### CROSS-REFERENCE TO RELATED APPLICATIONS

This application is related to and claims priority from U.S. Provisional Patent Application No. 61/514,957, filed on Aug. 4, 2011, by Lencic titled “Changeable Interactive Surface With Resizing, Zooming, Moving, Rotating and Other Manipulation Options/Controls”, which is incorporated herein by reference in its entirety.

### BACKGROUND

1. Statement of the Technical Field

Embodiments include systems and methods for providing an adjustable/changeable interactive electronic working or drawing surface used with computerized user interfaces, as well as user controls for changing the size, rotation, position and other parameters/characteristics of an interactive electronic working surface. More specifically, the present invention relates to sizing (i.e., extending/shrinking), rotating (i.e., landscape, portrait mode), moving and zooming (i.e., zoom in, zoom out) the interactive electronic working or drawing surface under the control of user selected actions, such as, but not limited to clicking/taping/swiping/touching, simply moving part of user body-eyes, moving hands in the air, head or upper limb or voice, or the like.

2. Description of the Related Art

Computers and other similar devices with a fixed display or monitor size typically use a graphics-based user interface to ease interaction between the user and the computer or between the user and the computer application program or software running on the computer to execute various actions, commands and/or tasks. Computer devices commonly use a fixed physical display monitor which includes a graphic-based user interface. This graphic-based user interface typically includes bitmap images to represent various software entities, shapes, controls, and the like. Many existing user interfaces maximally or partially fill the entire two dimensional display area of the display monitor, and operate using a special window or editor which opens when a user wants to change the size and other elements (e.g., color, size, texture, position, etc.) of the user interface surface. With these user interfaces, the user typically has to open a configuration window or pane and manually enter and save various data to change the size and other characteristics of the user interface's interactive working or drawing surface. It would be beneficial for a user to be able to make such changes without needing to manually change this data.

### SUMMARY

Systems and methods that allow a user to change the size, rotation, zoom and/or position of a drawing surface used with a graphics-based user interface or being used as graphics-based user interface are provided. This enables a user to change the size, rotation, zoom and/or position of the drawing surface directly without opening an editor or other window to change the characteristics based on user actions. For example, a user may manually extend drawing surface to present more information while the size and look of the display and graphic-based user interface remains unchanged.

Also disclosed are devices including a non-transient computer readable medium incorporating computer instructions including the above-referenced methods.

### BRIEF DESCRIPTION OF THE DRAWINGS

Embodiments will be described with reference to the following drawing figures, in which like numerals represent like items throughout the figures, and in which:

FIG. 1 depicts an exemplary user interface screen that is useful for understanding the present invention.

FIG. 2 depicts an exemplary user interface screen that is useful for understanding the present invention.

FIG. 3 depicts an exemplary user interface screen that is useful for understanding the present invention.

FIG. 4 is a flow diagram that is useful for understanding the present invention.

FIG. 5 depicts an exemplary user interface screen that is useful for understanding the present invention.

FIG. 6 is a block diagram of an exemplary system that is useful for understanding the present invention.

FIG. 7 is a schematic block diagram of an exemplary user device that is useful for understanding the present invention.

### DETAILED DESCRIPTION

The present invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

Systems and methods are advantageously provided for changing the size, position, rotation and other characteristics of the interactive/working/drawing surface (hereinafter, collectively, “drawing surface”) directly on the drawing surface where a user can change its characteristics with one or more gestures and/or actions, like click, press, tap, swipe, voice control, double click, double tap, moving part of body, etc. Controls for changing the characteristics of the drawing surface can also be positioned next to the interactive/working/drawing surface.

In this invention the controls for changing the size, position, rotation and other characteristics of the interactive/working/drawing surface (hereinafter, collectively, “drawing surface”) are implemented directly on the drawing surface where a user can change its characteristics with one or more gestures and/or actions, such as, but not limited to a click, press, tap, swipe, voice control, double click, double tap, moving part of body, etc.

Controls for changing the characteristics of the drawing surface can also be positioned next to the interactive/working/drawing surface. Also, embodiments may position controls both within and adjacent to the drawing surface.

For an example. In “real world”—i.e., non-computer—applications, people use large paper rolls when they need a larger drawing surface. One would thus unroll a paper to extend the drawing space. In a computerized “virtual world” a user can extend or shrink the size in horizontal, vertical, diagonal, circular and other two or three dimensional directions. The size changing increments may be pre-set by the computer's software or application program, or it can be specific by user input—e.g., speed of a swipe, time holding/pressing a button, how much user extends both arms, speed of moving hands, etc.

If the drawing surface is part of fixed graphics-based user interface, then the size of the graphics-based user interface, of which drawing surface is part of, cannot be manipulated, selected, or changed by a user. The size, position, rotation and/or ratio of the graphics-based user interface is defined by the device.

If the drawing surface is part of a changeable graphics-based user interface (i.e., application or software within another application or software) then the size of the graphics-based user interface, of which drawing surface is part of, may be manipulated, selected, or changed by a user. The size, position, rotation and/or ratio of the graphics-based user interface may be defined by the user.

The drawing surface may also define the usable limits of the graphics-based user interface. Graphic items, such as windows, used with the graphics-based user interface are limited to display within the drawing surface perimeter.

Described herein is a method and system that allow a user to manually change the size, position, rotation and/or ratio and other characteristics of the drawing surface such that a portion of the drawing surface resides outside a perimeter of the graphics-based user interface or computer display. A user would then perform some action, such as, but not limited to slide, drag, swipe, say and/or gesture, or the like, in order to see the information on the drawing surface.

One technical problem addressed by the invention is construction of a drawing surface and positioning of the characteristic changing controls which will enable a simple characteristic change of the drawing surface. At the same time the interactive/working/drawing surface would remain connected, it will also enable a coherent overview of displayed information, without any visible borders or separate areas. Thus, the drawing surface is preferably one area, but without limitation of starting parameters, such as default zoom, size or rotation.

A drawing surface can be a part of graphics-based user interface or it can be a graphics-based user interface as such that the drawing surface is at the same time the user interface. In the first case where the drawing surface is part of graphics-based user interface, the user interface does not change its size, position or look—it is fixed, except for rotation changes. In the second case where the drawing surface is at the same time a user interface, the size and position may change according to user's manipulation.

Also provided is a method and system which enables to the user to change the characteristics of the drawing surface which can be used as single user interface or as a part of existing user interface. This enables a user to change the size, rotation, zoom, and/or position as well as other characteristics of the drawing surface, and thus potentially obtain a larger space in which to draw, write, collect, present and save information. This can be extremely useful when a small display is used, which is often the case with various devices, such as, but not limited to, mobile phones, portable computers, tablets, monitors, interactive tables, etc. One problem with existing solutions for small displays is that a user has to open a new window or editor within the display area to set different parameters, such as color, image, style, size, position, orientation, etc., of the drawing surface. The present invention offers a single drawing surface with controls to change the size, rotation, position, and/or zoom directly from the drawing surface, or from a nearby control associated with the drawing surface.

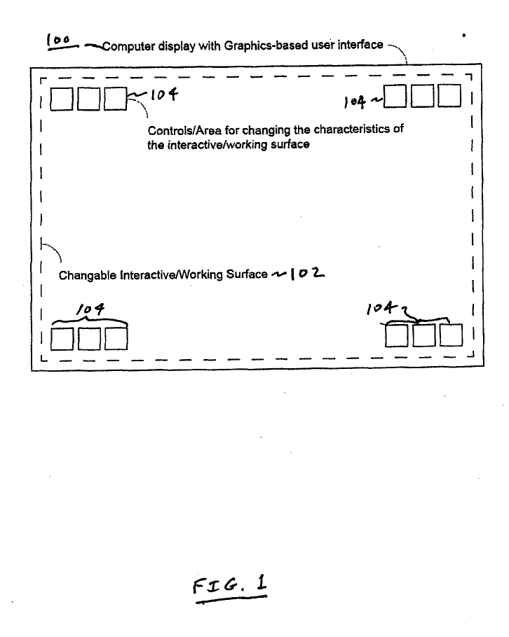

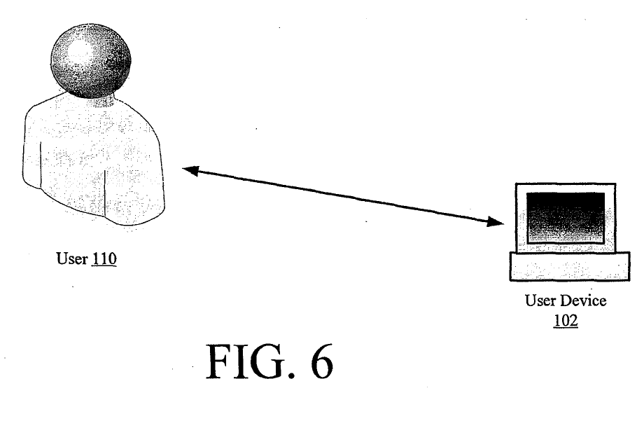

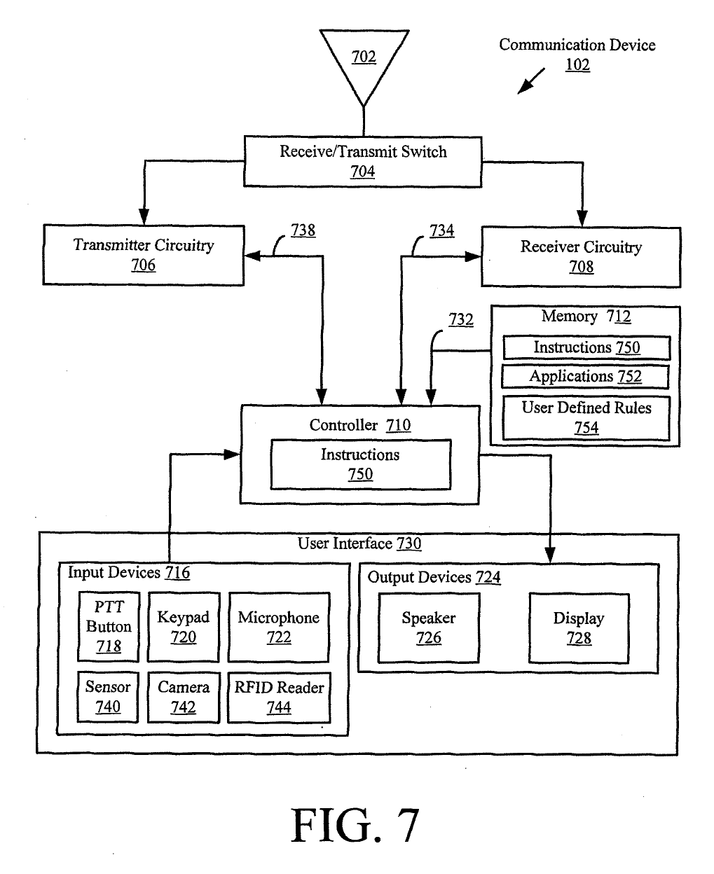

The present invention can be used in a variety of applications. Such applications include, but are not limited to, mobile phone applications, portable computer applications, PDA applications, portable navigation device applications, and any other application in which the user would benefit from changing the size, dimensions or other features of the available surface area. Exemplary implementing system embodiments of the present invention will be described below in relation to FIGS. 6-7. Exemplary method embodiments of the present invention will be described below in relation to FIGS. 1-5.

### Exemplary Systems Implementing the Present Invention

Referring now to FIG. 6, there is provided a block diagram of an exemplary system that is useful for understanding various embodiments of the present invention. The system includes comprises a user device. Also depicted is a user 110, for illustrative purposes. The system may include more, less or different components than those illustrated in FIG. 6. However, the components shown are sufficient to disclose an illustrative embodiment implementing the present invention.

The user device 112 may be configured to communicate with a server over a network to send and obtain additional information, although this is not required. Additional information, if used, can include, but is not limited to, information needed for uploading and downloading drawings or other data for the user 110 to review, update or otherwise work with.

Referring now to FIG. 7, there is provided a more detailed block diagram of the user device 112. The user device 112 will be described herein as comprising a mobile phone or a smart phone. However, the present invention is not limited in this regard. For example, the user device 112 can alternatively comprise a PDA, a tablet Personal Computer (“PC”), or the like.

Notably, the user device 112 can include more or less components than those shown in FIG. 7. For example, the user device 112 can include a wired system interface, such as a universal serial bus interface (not shown in FIG. 7). However, the components shown are sufficient to disclose an illustrative embodiment implementing the present invention.

As shown in FIG. 7, the user device 112 comprises an antenna 702 for receiving and transmitting Radio Frequency (RF) signals. A receive/transmit (Rx/Tx) switch 704 selectively couples the antenna 702 to the transmitter circuitry 706 and receiver circuitry 708 in a manner familiar to those skilled in the art. The receiver circuitry 708 demodulates and decodes the RF signals received from a network to derive information therefrom. The receiver circuitry 708 is coupled to a controller 710 via an electrical connection 734. The receiver circuitry 708 provides the decoded RF signal information to the controller 710. The controller 710 uses the decoded RF signal information in accordance with the function(s) of the user device 112. The controller 710 also provides information to the transmitter circuitry 706 for encoding and modulating information into RF signals. Accordingly, the controller 710 is coupled to the transmitter circuitry 706 via an electrical connection 738. The transmitter circuitry 706 communicates the RF signals to the antenna 702 for transmission to an external device.

The controller 710 stores the decoded RF signal information in a memory 712 of the user device 112. Accordingly, the memory 712 is connected to and accessible by the controller 710 through an electrical connection 732. The memory 712 can be a volatile memory and/or a non-volatile memory. For example, the memory 712 can include, but is not limited to, a Random Access Memory (RAM), a Dynamic Random Access Memory (DRAM), a Static Random Access Memory (SRAM), Read-Only Memory (ROM) and flash memory. The memory 712 can also have stored therein the software applications 752 and user-defined rules 754.

The software applications 752 may include, but are not limited to, applications operative to provide telephone services, network communication services, Internet connectivity and access services, commerce services, email services, web based services, and/or electronic calendar services, as well as software to provide a graphics-based drawing surface and controls for modifying various characteristics of the drawing surface.

As shown in FIG. 7, one or more sets of instructions 750 are stored in the memory 712. The instructions 750 can also reside, completely or at least partially, within the controller 710 during execution thereof by the user device 112. In this regard, the memory 712 and the controller 710 can constitute non-transient machine-readable media. The term “machine-readable media”, as used here, refers to a single medium or multiple media that store the one or more sets of instructions 750. The term “machine-readable media”, as used here, also refers to any medium that is capable of storing, encoding or carrying the set of instructions 750 for execution by the user device 112 and that cause the user device 112 to perform one or more of the methodologies of the present disclosure.

The controller 710 is also connected to a user interface 730. The user interface 730 is comprised of input devices 716, output devices 724, and software routines (not shown in FIG. 7) configured to allow a user to interact with and control software applications 752 installed on the computing device 102. Such input and output devices respectively include, but are not limited to, a display 728, a speaker 726, a keypad 720, a directional pad (not shown in FIG. 7), a directional knob (not shown in FIG. 7), a microphone 722, a Push-To-Talk (“PTT”) button 718, sensors 740, a camera 742 and a Radio Frequency Identification (“RFID”) reader 744.

### Exemplary Methods

FIGS. 1-3 present exemplary user interface screens 100, 200, 300 useful in understanding embodiments of the invention. The user interface screens 100, 200, 300 are presented to a user 110 using the display 728 of a user device 112. The user interface screens may vary to accommodate the display and input/output facilities of the particular communication device. For example, with a user device 112 with a relatively small display area, such as a smart phone, the exemplary user interface screens 100, 200, 300 may be compressed, abbreviated and/or divided into multiple pages of screens, as is known practice to those of skill in the relevant arts. Also, variations to the presented user interface screens 100, 200, 300 are expected in various embodiments.

FIG. 1 presents an exemplary graphics-based user interface display screen 100 with a changeable interactive/drawing/working surface 102 (hereinafter, drawing surface 102) having various controls/button areas 104 located within the drawing surface 102. The controls/button areas is provided to allow a user 110 to easily access controls/buttons for controlling various aspects of the drawing surface 102. It is envisioned that any of several controls and/or buttons may be provided in the controls/button areas 104, such as, but not limited to controls for changing the size, rotation, position, and/or zoom level of the drawing surface 102, and the like, without limitation.

It is also envisioned in an embodiment that some controls may be activated by simply moving a cursor over them, or, in some applications, by hand gestures, swiping motions, or other human interface technology. In one embodiment a camera associated with the user device 112 and appropriate computer software may be used to monitor the movements of the user 110 to determine when a gesture activates a control. In another embodiment, moving to the boundary of the drawing surface may activate a panning or expansion of the usable drawing surface 102.

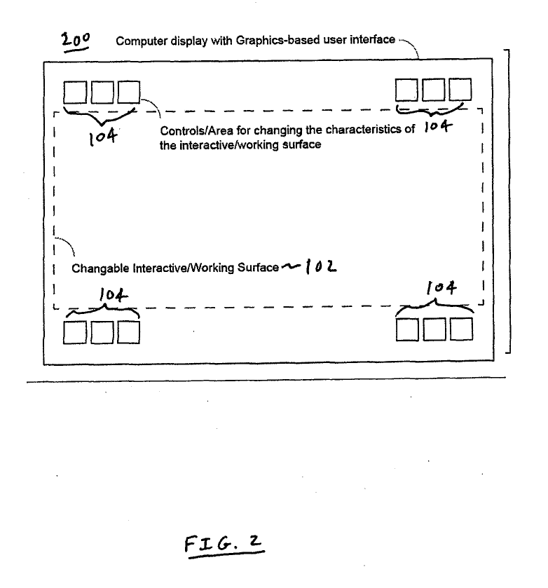

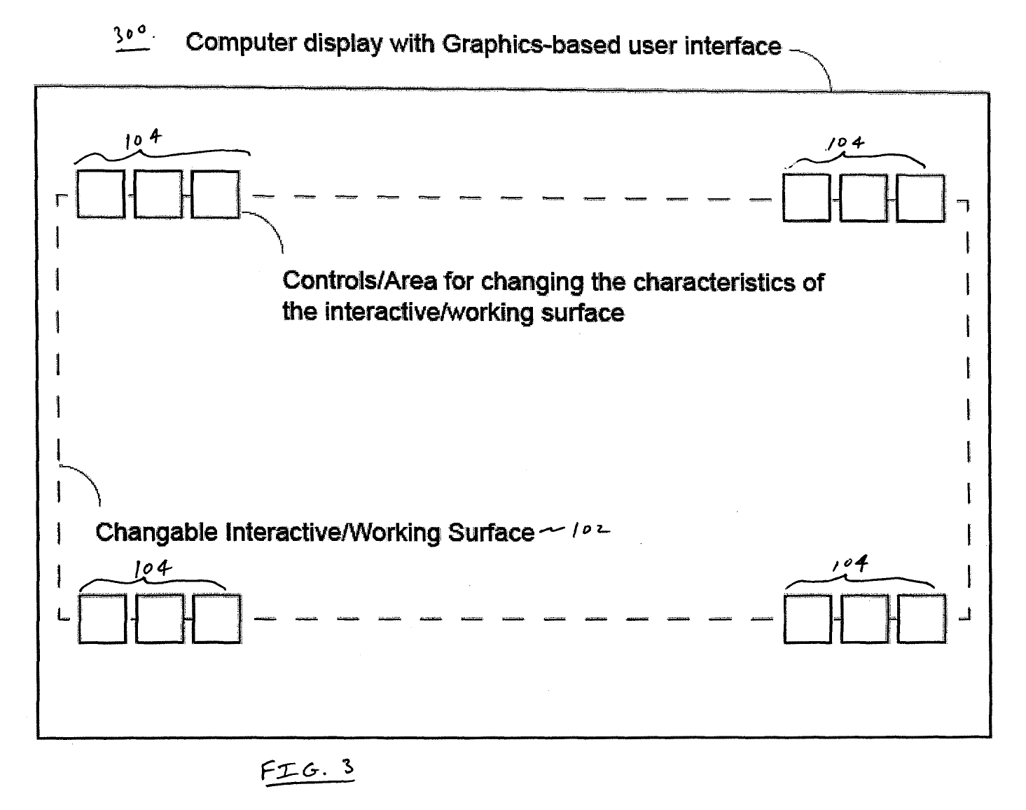

FIG. 2 illustrates an exemplary embodiment of graphics-based user interface and changeable drawing surface having controls/button areas 104 adjacent to the drawing surface 102. Although the user 110 would move a cursor or other pointing instrument outside the drawing surface 102 to manipulate the drawing controls or buttons, being adjacent to the drawing surface 102 allows the controls/buttons to still be easily accessible. Similarly, in an embodiment depicted in FIG. 3, the controls/button areas 104 may straddle the border of the drawing surface 102, allowing the controls and/or buttons to be manipulated while the user 110 is still operating a cursor or pointing instrument within the drawing surface 102, or from outside the drawing surface 102.

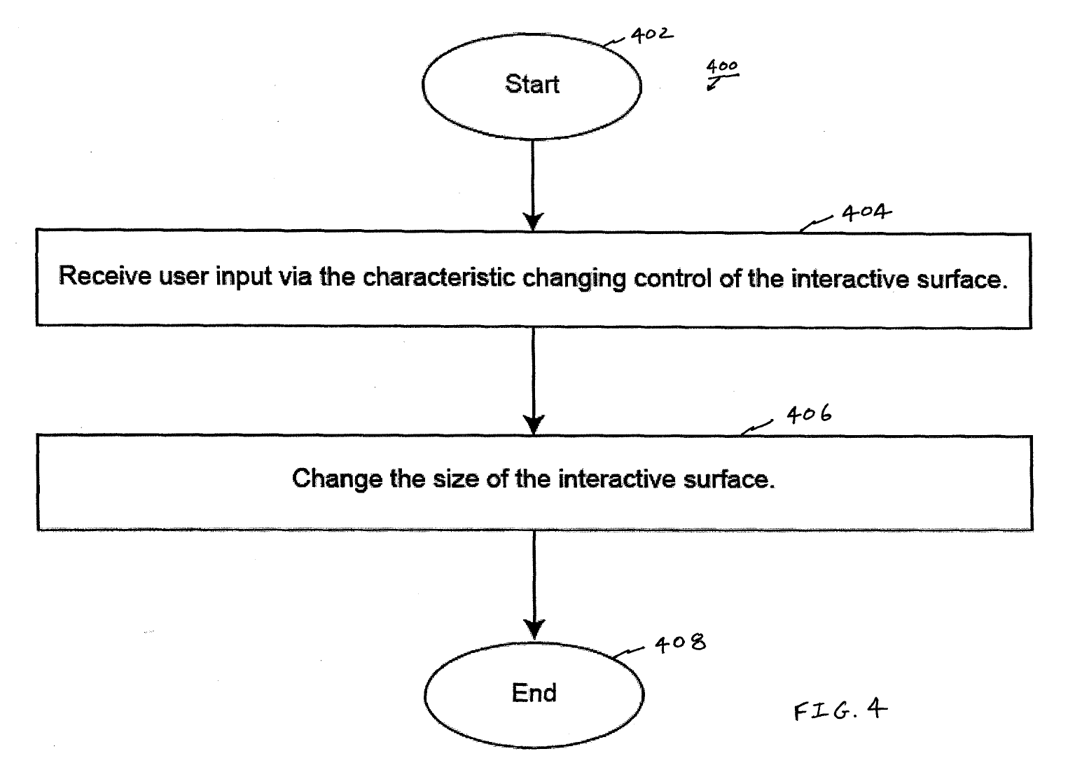

FIG. 4 provides an exemplary process flow 400 for changing only one characteristic—size—of a drawing surface 102 associated with a graphic-based user interface in accordance with an embodiment of the invention. The process begins with step 402, and continues to step 404, where a user input is received via a characteristic (size) changing control for the interactive drawing surface 102. For example, in one instance, the changing control for size may be a spinner wheel type control located in the controls/button areas 104. In this case, the user may move their cursor to the spinner control and click to increase the drawing surface 102 size. Alternatively, the control may be a single button for increasing the drawing surface 102 size and a separate button for decreasing the size, or another type of control, without limitation. Once the control has been activated, in step 406 the size of the interactive drawing surface 102 is changed.

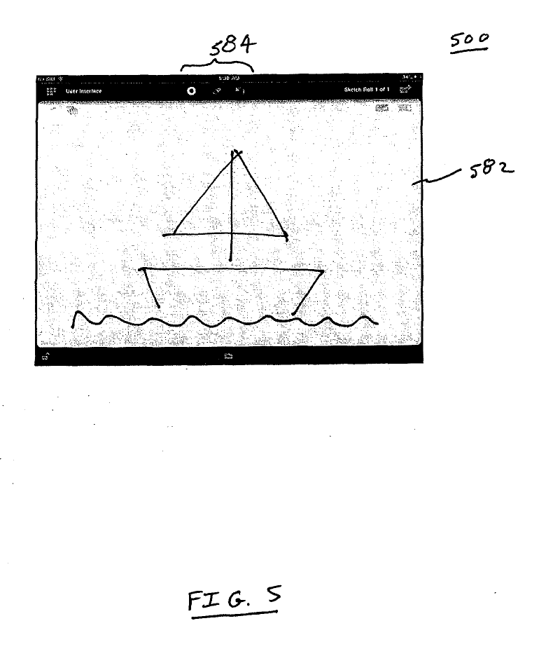

FIG. 5 provides an exemplary user interface screen 500 depicting a graphics-based user interface including a changeable drawing surface 582 associated with a graphics-based user interface having a graphics control buttons 584 for changing the drawing surface size. In this embodiment, the control buttons 584, like those of FIG. 2, are located outside the drawing surface 582.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the methods without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method of providing a graphics-based user interface (UI) on a device comprising an electronic circuit, an input device, and a display screen, the method comprising:
displaying, on the display device, a drawing surface and a plurality of characteristic changing controls associated with the drawing surface;
receiving, from the input device, an input signal of a user indicating an input directed to the one of the plurality of characteristic changing controls;
modifying a characteristic of the drawing surface by the electronic circuit in response to the input signal received from the input device to create a modified drawing surface; and,
displaying, on the display device, the modified drawing surface.

2. The method according to claim 1, wherein the plurality of characteristic changing controls are located on the display device within the drawing surface.

3. The method according to claim 1, wherein the plurality of characteristic changing controls are located on the display device adjacent to the drawing surface.

4. The method according to claim 1, wherein the plurality of characteristic changing controls are located on the display device both adjacent to and within the drawing surface.

5. The method according to claim 1, wherein the plurality of characteristic changing controls comprise a control to resize the drawing surface.

6. The method according to claim 1, wherein the plurality of characteristic changing controls comprise a control to rotate the drawing surface.

7. The method according to claim 1, wherein the plurality of characteristic changing controls comprise a control to zoom the drawing surface in and out.

8. The method according to claim 1, wherein the plurality of characteristic changing controls comprise a control to move the drawing surface within the display device.

9. A system, comprising
an input device;
a display screen; and
at least one electronic circuit configured to perform the following operations:
displaying, on the display device, a drawing surface and a plurality of characteristic changing controls associated with the drawing surface;
receiving, from the input device, an input signal of a user indicating an input directed to the one of the plurality of characteristic changing controls;
modifying a characteristic of the drawing surface by the electronic circuit in response to the input signal received from the input device to create a modified drawing surface; and,
displaying, on the display device, the modified drawing surface.

10. The system according to claim 9, wherein the wherein the plurality of characteristic changing controls are located on the display device within the drawing surface.

11. The system according to claim 9, wherein the plurality of characteristic changing controls are located on the display device adjacent to the drawing surface.

12. The system according to claim 9, wherein the plurality of characteristic changing controls are located on the display device both adjacent to and within the drawing surface.

13. The system according to claim 9, wherein the plurality of characteristic changing controls comprise a control to resize the drawing surface.

14. The system according to claim 9, wherein the plurality of characteristic changing controls comprise a control to rotate the drawing surface.

15. The system according to claim 9, wherein the plurality of characteristic changing controls comprise a control zoom the drawing surface in and out.

16. The system according to claim 9, wherein the plurality of characteristic changing controls comprise a control to move the drawing surface within the display device.

17. A device comprising a computer-readable storage medium, having stored thereon a computer program for controlling at least one function of at least one software application, the computer program having a plurality of code sections, the code sections executable by a computer to cause the computer to perform the steps of:
displaying, on a display device, a drawing surface and a plurality of characteristic changing controls associated with the drawing surface;
receiving, from an input device, an input signal of a user indicating an input directed to the one of the plurality of characteristic changing controls;
modifying a characteristic of the drawing surface in response to the input signal received from the input device to create a modified drawing surface; and,
displaying, on the display device, the modified drawing surface.

18. The device according to claim 17, wherein the plurality of characteristic changing controls are located with the drawing surface.

19. The device according to claim 17, wherein the input device is a computer touch screen.

20. The device according to claim 17, wherein the input device is a camera associated with the computer for detecting user movements.
